(19) United States
(12) Patent Application Publication
(10) Pub. No.: US 2012/0113928 A1
(43) Pub. Date: May 10, 2012

(54) METHOD FOR ALLOCATING BITS IN MULTIPLE INPUT MULTIPLE OUTPUT COMMUNICATION SYSTEM AND RECORDING MEDIUM FOR RECORDING PROGRAM THEREFOR

(75) Inventors: Seung Hoon HWANG, Seoul (KR); Cha Eul JEON, Gyeonggi-do (KR)

(73) Assignee: Dongguk University Industry-Academic Cooperation Foundation, Seoul (KR)

(21) Appl. No.: 13/351,446

(22) Filed: Jan. 17, 2012

Related U.S. Application Data
(63) Continuation of application No. PCT/KR2010/004715, filed on Jul. 19, 2010.

(30) Foreign Application Priority Data
Jul. 17, 2009 (KR) 10-2009-0065591

(51) Int. Cl. H04W 72/04

(52) U.S. Cl. 370/329

(57) ABSTRACT

The present invention relates to a method for allocating bits in a multiple input multiple output communication system that can improve transmission by allocating bits having high priority to a particular antenna selected by considering channel state of transmitting antennas, and a recording medium written with a program for said method. The method of allocating bits includes: generating bits through channel coding and rearranging the bits in an interleaving fashion; determining whether symbol mapping based on priority is to be applied, based on channel information of a receiving side; rearranging the bits or selecting a particular antenna, according to said determination; and modulating the rearranged bits and transmitting the bits through the selected antenna.

### CROSS-REFERENCE TO RELATED APPLICATIONS

This application is a continuation of PCT/KR2010/004715 filed Jul. 19, 2010, which claims the benefit of Korean Patent Application No. 10-2009-0065591, filed with the Korean Intellectual Property Office on Jul. 17, 2009, the disclosure of which is incorporated herein by reference in its entirety.

### BACKGROUND

1. Technical Field

The present invention relates to a multiple input multiple output communication system, more specifically to a method for allocating bits in a multiple input multiple output communication system and a recording medium for recording a program therefor that can improve the transmission performance by allocating bits having higher priority to a particular antenna that is selected by considering the channel state of transmission antennas.

2. Background Art

There has been an increased demand for a method for efficiently transmitting data within limited frequencies in mobile communications environments where data transmission is increasingly faster. As a standard system for a method for solving this, a multiple antenna technology is currently discussed. Even in the 3GPP LTE (Long Term Evolution), which is considered for the next generation communication system, various MIMO (Multiple Input Multiple Output) technologies have been proposed.

The conventional mobile communication systems have been developed to overcome the fading in the mobile communication environments for mostly voice-oriented services. However, as the mobile communication systems shift the services to data communication that includes multimedia contents, high-speed data transmission is required, particularly for high-speed data transmission in a forward link that has a great amount of data.

Accordingly, a MIMO (Multiple Input Multiple Output) technology has been suggested in order to dramatically improve the transmission rate of data by using multiple transmission/reception antennas.

The MIMO technology uses a spatial multiplexing/demultiplexing method, in which different data are transmitted through different transmission antennas from a transmitter and the transmission data are identified through proper signal processing at the receiver.

Therefore, as the number of transmission/reception antennas is simultaneously increased, the channel capacity is increased, making it possible to transmit more data.

The MIMO technologies suggested in the LTE system can be divided into two major categories. One is an open loop method, in which diversity or multiplexing gain for multiples channels of multiple input/output is obtained without channel state information, and the other is a closed loop method, in which power is adjusted or weight is multiplied to a transmission signal according to the channel state information.

The open loop transmission method has an STC (Space Time Coding) method for obtaining diversity gain or symbol gain and the spatial multiplexing method for transmitting other symbols in parallel to an antenna in order to improve the transmission rate.

The diversity gain and the multiplexing gain can be obtained through both methods, but codes have been suggested for achieving the maximum transmission rate and the maximum diversity gain in the tradeoff relation. The closed loop method can increase the capacity more than the open loop method because the channel state information is utilized.

The closed loop transmission method has an antenna selection process, in which antennas that transmit or receive a signal is selected and the signal is allowed to be transmitted or received by some antennas.

It is required at a transmitting side that a reference signal is continuously sent so that a receiving side can check the channel state, and the receiving side selects the transmission/receiving antenna that fits selection criteria based on this. Used for the selection criteria can include selecting a combination that maximizes mutual information and selecting a combination that maximizes the signal-to-noise ratio (SINR) of reception.

In the conventional antenna selection method, data is transmitted from selected antennas, or power control or weight is given to the selected antennas. The data transmitted through the antenna selected in this way has the same priority as the bits transmitted to other antennas.

FIG. 1 shows a block diagram of a conventional multiple antenna system.

In order to transmit frames simultaneously using two antennas, each frame is separately channel-encoded, interleaved and modulated before being transmitted through each antenna.

In other words, it can be inferred that the multiple antenna system transmits the bits having the same priority because the frames transmitted through multiple antennas are independently processed in the receiving side and the transmitting side.

However, although in the conventional multiple antenna system, the transmitter receives a channel state from the receiver to utilize power control or weight, errors can still occur in a frame sent through an antenna, of which the channel state is not good, because the frames are transmitted through several antennas at the same time.

### SUMMARY

Contrived to solve the above problems of the conventional multiple antenna system, the present invention provides a method for allocating bits in a multiple input multiple output communication system in which transmission is improved by allocating bits having higher priority to a particular antenna that is selected by considering the channel state of transmission antennas in the multiple input multiple output communication system.

The present invention provides a wireless communication system that selects an antenna by considering allocating bits having higher priority so that the system can have an improved transmission, by determining which antenna has a good channel state, based on a channel state signal on a receiving side, and transmitting data having higher priority through the determined antenna.

The present invention provides a recording medium for recording a program for allocating bits in a multiple input multiple output communication system in which transmission is improved by allocating bits having higher priority to a particular antenna that is selected by considering the channel state of transmission antennas in the multiple input multiple output communication system.

A method of allocating bits in a multiple input multiple output communication system for data transmission of a packet transmission system having multiple antennas in accordance with the present invention can include: generating bits through channel coding and rearranging the bits in an interleaving fashion; determining whether symbol mapping based on priority is to be applied, based on channel information of a receiving side; rearranging the bits or selecting a particular antenna, according to said determination; and modulating the rearranged bits and transmitting the bits through the selected antenna.

The method can also include, after the transmitting of the bits, estimating channel information based on received data and feeding back the estimated channel information to a receiver.

The method can also include, after the transmitting of the bits, checking whether the receiving side properly received data, and the step of checking can be carried out by receiving channel information of the receiving side and checking channel state of each antenna.

The channel coding can use a coding method that generates systematic bits.

The interleaving fashion can include: rearranging the bits; and mixing the bits that are rearranged and separated.

The rearranging of the bits can be carried out by arranging the bits in such a way that systematic bits and parity bits are separately positioned.

The channel information of the receiving side can be a retransmission request signal of a frame if ARQ (Automatic Repeat reQuest) is used and can be SINR information of each antenna if pilot symbol is used.

The rearranging of the bits can be carried out by arranging the bits in such a way that systematic bits and parity bits are positioned according to priority pattern based on modulation method.

The selecting of a particular antenna can include: receiving and checking the channel information of the receiving side; and selecting an antenna through which systematic bits are to be sent.

The modulating of the rearranged bits can be carried out by mapping the rearranged bits between bit symbols of constellation according to a bit priority pattern if SMP is applied.

In the method for allocating bits in a multiple input multiple output communication system in accordance with the present invention for achieving another object, the determining of whether symbol mapping based on priority is to be applied can include, if ARQ (Automatic Repeat reQuest) is used: checking for an error in a frame received by the receiving side; estimating an antenna having a good channel state based on the checked error in the frame; and feeding back predicted channel state information to a transmitting side.

In the step of checking for an error, a bit error of a frame can be measured.

The antenna having a good channel state can be one of antennas excluding an antenna that has carried out transmission of systematic bits, in case the error has occurred in every frame.

The antenna having a good channel state can be an antenna that has carried out transmission of systematic bits, in case the error has occurred not in every frame.

The predicted channel state information can be information for determining an antenna through which systematic bits are to be transmitted in next transmission.

In the method for allocating bits in a multiple input multiple output communication system in accordance with the present invention for achieving another object, the determining of whether symbol mapping based on priority is to be applied can include, in case a pilot symbol insertion method is used: checking a pilot symbol of a frame received by the receiving side; estimating an antenna having a good channel state based on checked information; and feeding back predicted channel state information to a transmitting side.

In the step of checking, the SINR (Signal to Interference Ratio) of each channel can be measured.

The antenna having a good channel state can be an antenna having a greatest SINR.

The predicted channel state information can be information for determining an antenna through which systematic bits are to be transmitted in next transmission.

With the method for allocating bits in a multiple input multiple output communication system in accordance with the present invention and the recording medium having a program therefor written therein, transmission can be improved by allocating bits having high priority to a particular antenna selected by considering the channel state of transmitting antennas.

Moreover, data having high priority can be transmitted through an estimated antenna that has a good channel state based on the channel state signal of the receiving side.

Furthermore, transmission of the system can be further improved by using the symbol mapping based on priority in case particular channel information is fed back.

### BRIEF DESCRIPTION OF THE DRAWINGS

FIG. 1 shows a block diagram of a conventional multiple antenna system.

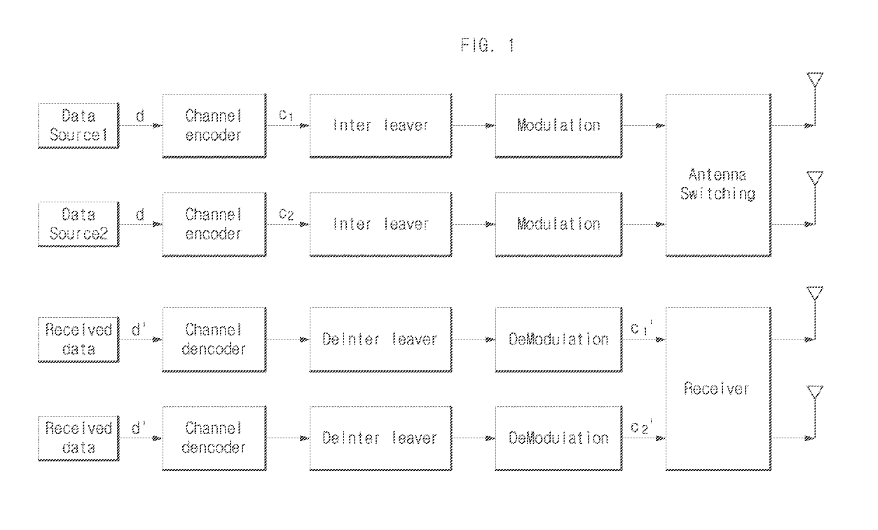

FIG. 2 is a block diagram showing an embodiment of a channel encoding method used in the present invention.

FIG. 3 is a block diagram showing an embodiment of an interleaving method in accordance with the present invention.

FIG. 4 is a block diagram showing an embodiment of a bit rearrangement method for SMP in accordance with the present invention.

FIG. 5 shows the configuration of an embodiment of a symbol mapping method of bits modulated in 16 QAM in accordance with the present invention.

FIG. 6 shows the configuration of an embodiment of a method for determining application of SMP using channel information in accordance with the present invention.

FIG. 7 is a block diagram of a multiple antenna system when SMP in accordance with a first embodiment of the present invention is applied.

FIG. 8 is a block diagram of the multiple antenna system when SMP in accordance with the first embodiment of the present invention is not applied.

FIG. 9 is a flowchart showing a bit allocation method in a multiple input multiple output communication system in accordance with the first embodiment of the present invention.

FIG. 10 is a block diagram of a multiple antenna system in accordance with a second embodiment of the present invention.

FIG. 11 is a flowchart showing a bit allocation method in a multiple input multiple output communication system in accordance with the second embodiment of the present invention.

### DETAILED DESCRIPTION

Hereinafter, certain embodiments of a method for allocating bits in a multiple input multiple output communication system and a recording medium recording a program for said method in accordance with the present invention will be described.

Features and advantages of the method for allocating bits in a multiple input multiple output communication system and the recording medium recording a program therefor will be apparent through the below detailed description for the embodiments.

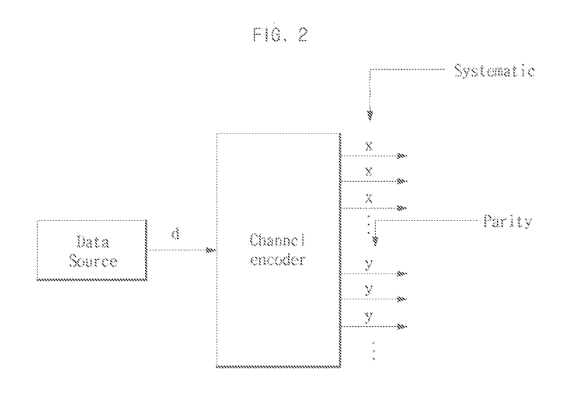

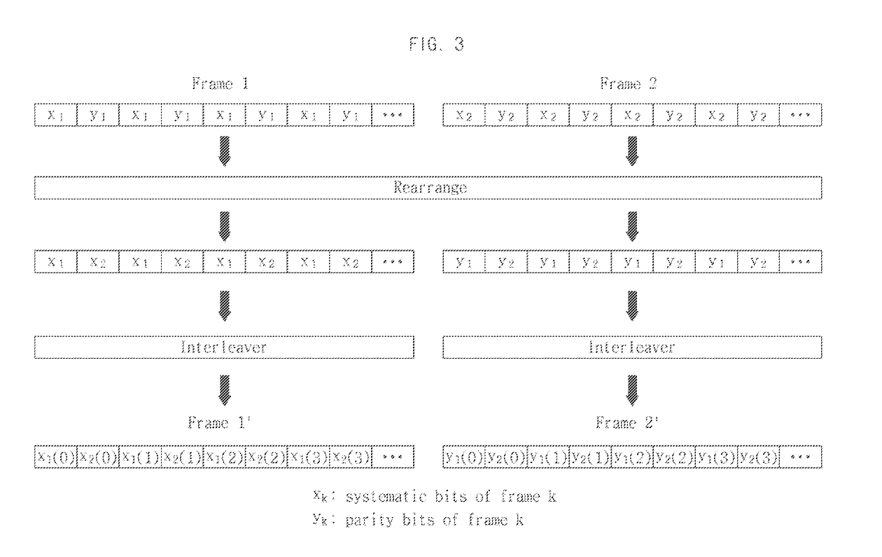

FIG. 2 is a block diagram showing an embodiment of a channel encoding method used in the present invention, and FIG. 3 is a block diagram showing an embodiment of an interleaving system in accordance with the present invention.

In a wireless communication system using a method of selecting an antenna by considering allocation of bits having higher priority in accordance with the present invention, the priority of bits transmitted through a selected antenna is enhanced when antenna selection is made by considering the channel state of each antenna in a multiple antenna system.

FIG. 2, which shows a channel encoding system used in the present invention, uses a channel encoding method that creates systematic bits, which are expressed with “x”, and parity bits, which are expressed with “y.”

In FIG. 3, which shows an interleaving method in accordance with the present invention, it is assumed that Frame 1 and Frame 2 are respectively transmitted through two antennas.

The basic concept of the interleaving method according to the present invention is that the higher priority systematic bits and the lower priority parity bits are distinguished and arranged and then the distinguished bits are mixed again.

In other words, both Frame 1 and Frame 2 have systematic bits and parity bits for the channel encoding method used in the invention illustrated in FIG. 2. Then, when both Frames are sent to an interleaver, the systematic bits of Frame 1 and the systematic bits of Frame 2 are combined to form one frame, and the remaining parity bits of both Frames form one frame.

Then, the bits of the distinguished Frames are mixed again.

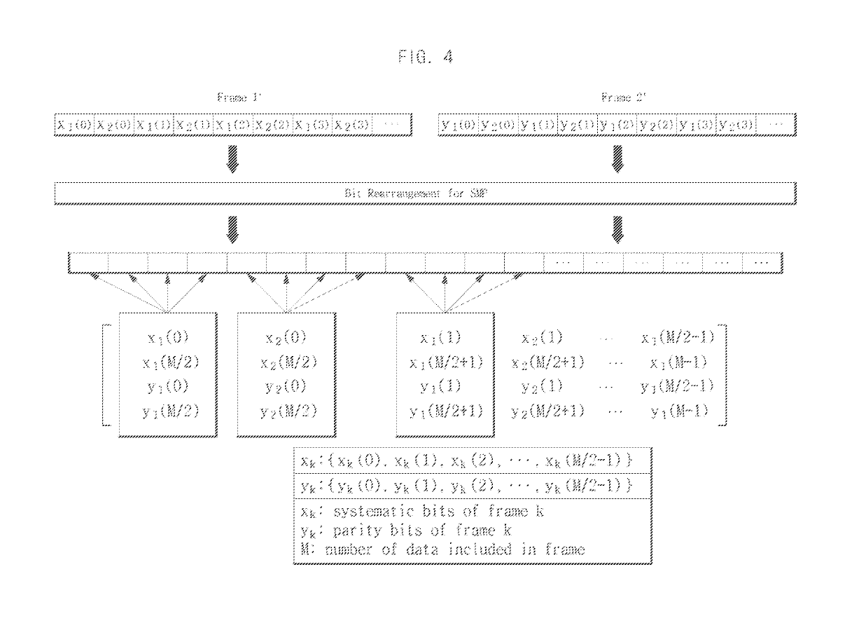

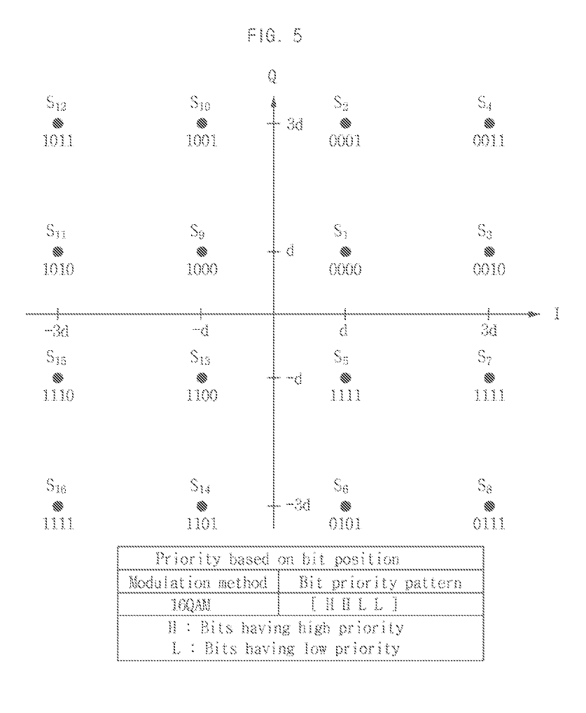

FIG. 4 is a block diagram showing an embodiment of a bit rearrangement method for SMP in accordance with the present invention, and FIG. 5 shows the configuration of a symbol mapping method of bits modulated in 16 QAM in accordance with the present invention.

Described below is an embodiment of a bit rearrangement method for SMP in accordance with the present invention.

Assuming that a 16 QAM modulation method is used, the basic concept of the bit rearrangement method for SMP in accordance with the present invention is that the bits are rearranged to match with the bit priority pattern of 16 QAM in order to apply the higher priority systematic bits and the lower priority parity bits to SMP.

In other words, both Frame 1 and Frame 2 have systematic bits and parity bits for the interleaving method shown in FIG. 3.

Then, according to the bit priority pattern in the 16 QAM modulation method shown in FIG. 5, the bits of both Frames are rearranged in such a way that Frame 1′ is mapped to first and second bits that have higher priority and Frame 2′ is mapped to third and fourth bits that have lower priority.

Expressing the above SMP application process in numerical formulas by referring to FIG. 4, the data included in Frame 1′ and Frame 2′ having been interleaved can be expressed in numerical formulas shown in the table of FIG. 4. And the bit rearrangement of Frame 1′ and Frame 2′ is performed in a matrix form shown in FIG. 4.

Described below is an embodiment of a symbol mapping method of bits modulated in 16 QAM in accordance with the present invention. It will be assumed that the 16 QAM modulation method is used.

The basic concept of the symbol mapping method of bits modulated in 16 QAM in accordance with the present invention is that performance is improved by transmitting systematic bits mapped to positions of bits having higher priority and parity bits mapped to positions of bits having lower priority based on the priority characteristics according to the positions.

As shown in FIG. 5, the first bits are “1” below 0 and “0” above 0 on the I axis.

The second bits are “1” above 0 and “0” below 0 on the Q axis.

The third bits are “1” below 2d and above 2d and “0” between 2d and 2d.

Here, the first and second bits higher priority, and the third and fourth bits have lower priority.

In the matrix shown in FIG. 4, it can be inferred that each column made up of 4 bits represents one symbol and the symbol mapping for the bit priority pattern is performed along [II II L L].

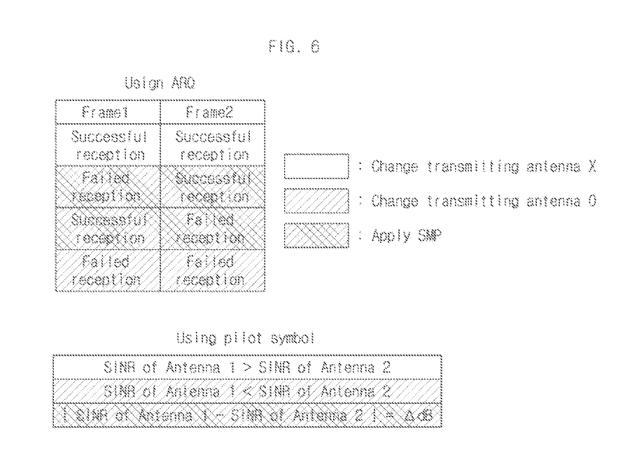

FIG. 6 shows an embodiment of a method for determining application of SMP using channel information in accordance with the present invention.

The method for determining application of SMP (Symbol Mapping based on Priority) using channel information in accordance with the present invention includes a method using an ARQ (Automatic Repeat request) and a method using a pilot symbol.

Described hereinafter is the method for determining application of SMP.

Assuming that Frame 1 and Frame 2 are transmitted through two antennas, the basic concept of determining application of SMP in accordance with the present invention is that the higher priority systematic bits are utilized if it is not certain to select an antenna that has a clearly better channel state.

If the channel information is obtained through ARQ and only one of Frame 1 and Frame 2 is successfully received after any error of Frame 1 and Frame 2 is checked by a receiving side, a transmitting side, which is fed back with a confirmation of Frame success on the receiving side, applies SMP. As described above, this is because it is not clear to determine that the channel state of one of the antennas is good if only one of the two frames is successfully received.

In case the channel information is obtained through the pilot symbol and the difference of SINR is not so great between two antennas after the SINR of the two antennas is measured on the receiving side, the transmitting side, which is fed back with the SINR information of the antenna on the receiving side, applies SMP. As described above, this is because it is not clear to determine that the channel state of one of the antennas is good if the difference of SINR between the two antennas is not so great.

Described below with reference to FIG. 6 is a method for selecting an antenna through which the systematic bits are transmitted based on the channel information.

It will be assumed that Frame 1 and Frame 2 are transmitted through two antennas (Antenna 1 and Antenna 2) and that the systematic bits are transmitted through Antenna 1.

The basic concept of the method for selecting an antenna through which the systematic bits will be transmitted in accordance with the present invention is that, if ARQ is used, the channel state of the antenna through which the systematic bits are transmitted is good if all frames transmitted are successfully received and, if the pilot symbol is used, the channel state of the antenna through which the pilot symbol having a high SINR is transmitted is good.

In case the channel information is obtained through ARQ, the transmitting antenna is not changed if Frame 1 and Frame 2 are both checked for an error by the receiving side and then are both successfully received, and the transmitting antenna is changed if both Frame 1 and Frame 2 fail to be successfully received. As described above, this is because the channel state of the antenna through which the systematic bits are transmitted is good if all of the transmitted frames are successfully received.

In case the channel information is received through the pilot symbol, the transmitting antenna is not changed if the two antennas are measured for their SINR and the SINR of Antenna 1 is greater than the SINR of Antenna 2, and the transmitting antenna is changed if the SINR of Antenna 2 is greater than the SINR of Antenna 1. This is because, as described above, the channel state is good for the antenna through which the pilot symbol having a greater SINR is transmitted.

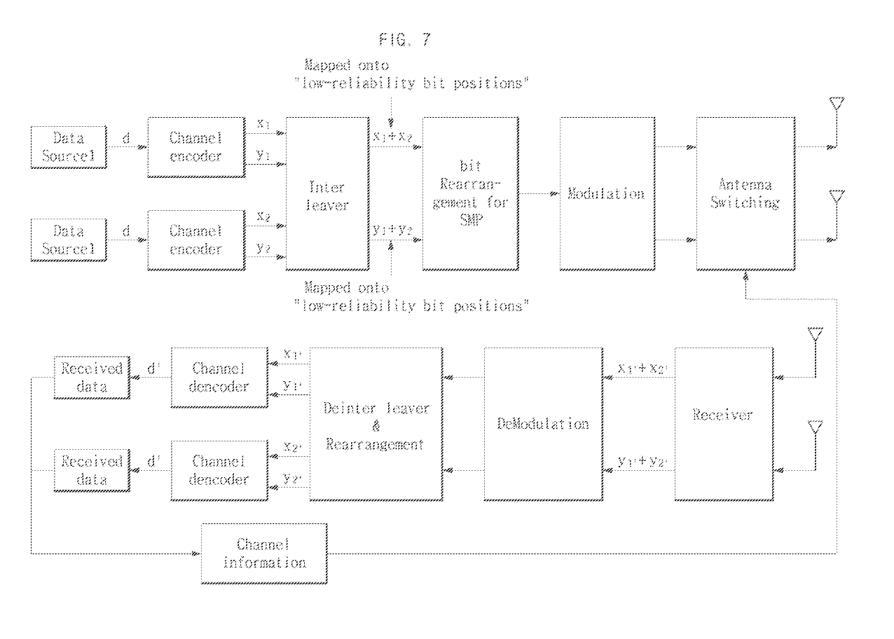

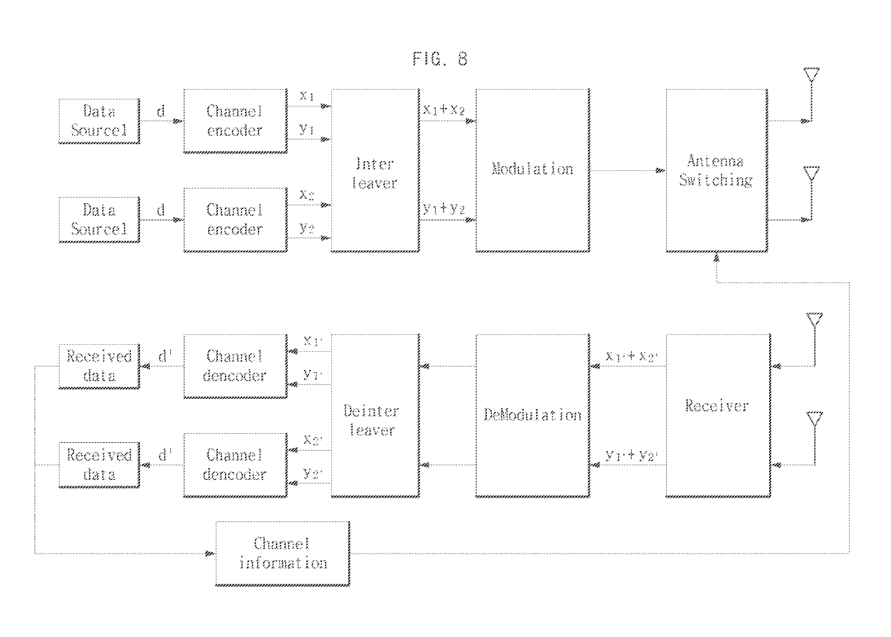

FIG. 7 is a block diagram of a multiple antenna system when SMP in accordance with a first embodiment of the present invention is applied, and FIG. 8 is a block diagram of the multiple antenna system when SMP in accordance with the first embodiment of the present invention is not applied.

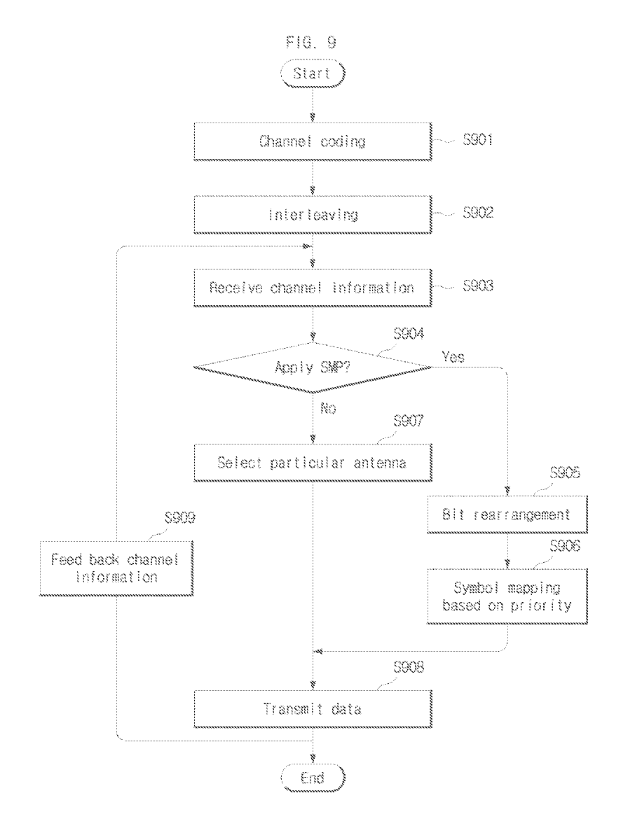

Furthermore, FIG. 9 is a flowchart showing a bit allocation method in a multiple input multiple output communication system in accordance with the first embodiment of the present invention.

The method of allocating bits having higher priority shown in FIG. 9 in accordance with an embodiment of the present invention includes the following steps.

Firstly, bits having higher priority are created through channel coding (S901).

For channel coding, a coding method of creating systematic bits is used.

Then, bits having higher priority and bits having lower priority are rearranged by a particular interleaving method (S902).

Here, the bits are rearranged in such a way that the higher priority systematic bits and the lower priority parity bits are separately positioned.

Then, channel information is received (S903), and it is determined whether SMP (Symbol Mapping based on Priority) is to be applied based on the channel information of the receiving side (S904).

Here, the channel information of the receiving side is a retransmission request signal of a frame if ARQ is used, and is SINR information of each antenna if the pilot symbol is used.

Then, depending on whether SMP is applied, the bits are rearranged if SMP is applied (S905), and a particular antenna is selected if SMP is not applied (S907).

Here, in the step of S905 in which the bits are rearranged, the bits are rearranged in such a way that the systematic bits and the parity bits are positioned according to the priority pattern based on the modulation method.

The particular antenna is selected by receiving and checking the channel information of the receiving side and selecting an antenna to which the systematic bits are to be sent.

Then, the rearranged bits are modulated (S906), and the bits are transmitted through the selected antenna (S908).

Here, the rearranged bits are modulated by mapping the rearranged bits between bit symbols of constellation according to the bit priority pattern if SMP is applied.

Then, based on the received data, the channel information is estimated, and the estimated channel information is fed back to a receiver (S909).

Here, after the bits are transmitted, it is checked whether the receiving side correctly received the data, by receiving the channel information of the receiving side and checking the channel state of each antenna.

Hereinafter, an antenna allocation method in accordance with a first embodiment of the present invention will be described by assuming that two frames are transmitted through two transmitting antennas and two receiving antennas.

The basic concept of a method of allocating bits having higher priority in accordance with the first embodiment of the present invention is that bits having higher priority are transmitted through a selected antenna.

Two frames are encoded by a channel coding method that generates systematic bits, and systematic bits and parity bits are mixed in the encoded bits.

Later, among the encoded bits, the systematic bits are collected in one frame and the remaining parity bits are collected in another frame, by a particular interleaving method considering the number of antennas.

Then, the bits in each frame are mixed so as to obtain an interleaving gain. A transmitter determines whether symbol mapping based on bit priority is to be applied, based on the channel information from the receiver.

In case the symbol mapping based on bit priority is applied, the frames having passed through the interleaver rearrange the bits in order to apply the symbol mapping. The rearranged bits are modulated according to the bit priority pattern of a modulation method, and the modulated symbols are transmitted through the antennas.

In case the symbol mapping based on priority is not applied, the transmitter selects the antenna through which the systematic bits are to be transmitted, based on the channel information. Among the frames having passed through the interleaver, a frame encompassing the systematic bits is transmitted through the selected antenna. This is because, as described above, the bits having higher priority in the two frames are transmitted through the selected antenna.

After the two transmitted frames are demodulated in the receiver, the two frames are returned to bit arrangement of the original frames after having passed through a deinterleaver. Later, the receiving side assesses status information of the channel through received data.

The receiving side feeds back the status information of the channel to the transmitter to determine whether symbol mapping based on priority is to be applied and to select the antenna through which the systematic bits are to be transmitted.

Described hereinafter is a method of allocating bits in a multiple antenna system in accordance with a second embodiment of the present invention.

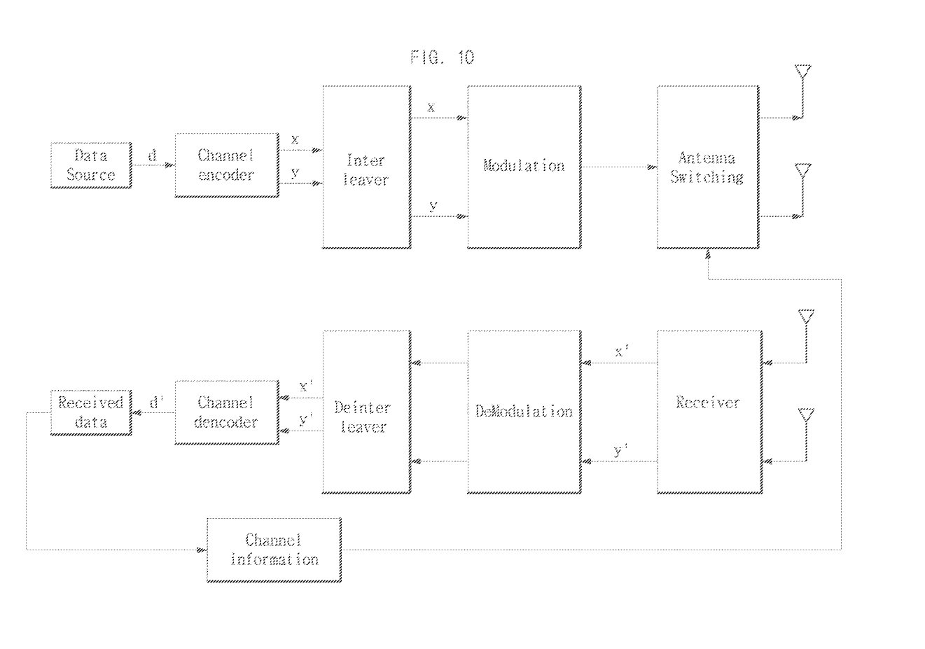

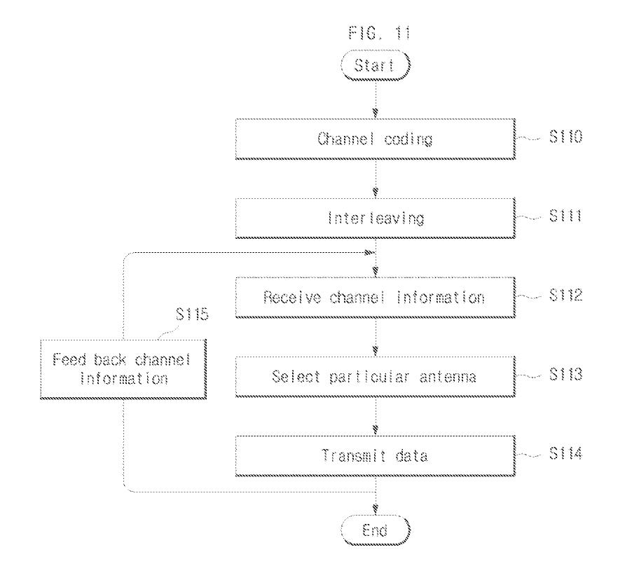

FIG. 10 is a block diagram of a multiple antenna system in accordance with a second embodiment of the present invention, and FIG. 11 is a flowchart showing a bit allocation method in a multiple input multiple output communication system in accordance with the second embodiment of the present invention.

Described hereinafter is a method of allocating bits with reference to FIGS. 10 and 11, by assuming that one frame is transmitted through two transmitting antennas and two receiving antennas.

The basic concept of the method of allocating bits having higher priority in accordance with the second embodiment of the present invention is that bits having higher priority of one frame are transmitted through a selected antenna.

The basic concept of antenna selection through prediction of channel state is that the channel state of the antenna that transmitted systematic bits is good if the transmitted frame is successfully received.

The processes on the transmitting side are identical to the channel coding method and the interleaving method of the first embodiment of the present invention, except that two frames are converted to one frame, the symbol mapping based on priority is not used, and ARQ is used to obtain the channel information (S110, S111).

Firstly, the frame transmitted by the transmitter is demodulated and then is passed through the deinterleaver and returned to bit arrangement of the original frame. Later, the receiving side can check for any error in the received frame and predict the channel state of the two antennas.

If the error in the frame is checked to be above a criterion, it can be predicted that the state of the antenna that transmitted the systematic bits is not good. Likewise, if the error in the frame is checked to be below the criterion, it can be predicted that the state of the antenna that transmitted the systematic bits is good.

The transmitting side feeds back this channel state information of the antenna to the receiving side. This is because, as described above, the channel state is good for the antenna that transmitted the systematic bits if the transmitted frame is successfully received.

The channel information sent by the receiving side is received (S 112); the antenna having a good channel state is selected by the transmitting side based on the channel information (S113); and the systematic bits of the channel-coded and interleaved data of the next frame is transmitted through this antenna, and the parity bits are transmitted through the unselected antenna (S 114). As described above, this is based on the concept that bits having higher priority of one frame is transmitted through the selected antenna.

The frame transmitted by the transmitter is demodulated and then is passed through the deinterleaver to return to bit arrangement of the original frame. Later, the receiving side assesses the channel state information through the received data.

The receiving side feeds back the channel state information to the transmitter to use the channel state information for selecting the antenna through which the systematic bits are to be transmitted (S115).

As such, in a wireless communication system using antenna selection by considering allocation of bits having higher priority in accordance with the present invention, the antenna having a good channel state is estimated based on the channel information of the receiving side.

Moreover, based on the fact that systematic bits have higher priority, the transmitting antenna having a good channel state transmits these bits having higher priority, and in case particular channel information is fed back, the SMP method is used, thereby further improving the transmission performance of the system.

The method for allocating bits in a multiple input multiple output communication system in accordance with the present invention described hitherto can be realized in a computer-readable code in a recording medium that can be read by a computer.

For example, the computer-readable recording medium can have a program written therein for executing the steps of generating bits of high priority through channel coding and rearranging the bits in an interleaving method, determining whether SMP is to be applied based on the channel information of the receiving side, rearranging the bits or selecting a particular antenna based on the determination, and modulating the rearranged bits and transmitting the bits through the selected antenna, for data transmission of a packet transmission system having multiple antennas.

Moreover, in case an ARQ method is used, the computer-readable recording medium can have a program written therein for executing the steps of checking for an error in the frame received by the receiving side, estimating an antenna having a good channel state based on the checked frame error, and feeding back the predicted channel state information to the transmitting side, for data transmission of a packet transmission system having multiple antennas.

Moreover, in case a pilot symbol insertion method is used, the computer-readable recording medium can have a program written therein for executing the steps of checking a pilot symbol of a frame received by the receiving side, estimating an antenna having a good channel state based on the checked information, and feeding back the predicted channel state information to the transmitting side, for data transmission of a packet transmission system having multiple antennas.

It shall be appreciated that the programs written in the computer-readable medium are not restricted to the above description and can include other actions for executing a method in accordance with an embodiment of the method for allocating bits in a multiple input multiple output communication system of the present invention.

The computer-readable recording medium can include any kind of recording device in which data readable by a computer system is stored. Examples of the computer-readable recording medium can include ROM, RAM, CDROM, magnetic tape, floppy disk, optical data storage, etc., and it is also possible that the computer-readable recording medium is realized in the form of a carrier wave (e.g., transmission through the Internet). Furthermore, it is possible that the computer-readable recording medium is dispersed in a networked computer system and that the computer-readable code is stored and executed in a dispersed manner.

It shall be appreciated through the above description that there can be a variety of permutations and modifications by anyone of ordinary skill in the art without departing from the technical ideas of the present invention.

Therefore, the technical scopes of the present invention shall not be restricted by the description of the embodiment(s) but shall be defined by the claims that are appended below.

What is claimed is:

1. A method of allocating bits in a multiple input multiple output communication system for data transmission of a packet transmission system having multiple antennas, the method comprising:
generating bits through channel coding and rearranging the bits in an interleaving fashion;
determining whether symbol mapping based on priority is to be applied, based on channel information of a receiving side;
rearranging the bits or selecting a particular antenna, according to said determination; and
modulating the rearranged bits and transmitting the bits through the selected antenna.

2. The method of claim 1 further comprising, after the transmitting of the bits, estimating channel information based on received data and feeding back the estimated channel information to a receiver.

3. The method of claim 1 comprising, after the transmitting of the bits, checking whether the receiving side properly received data,
wherein said step of checking is carried out by receiving channel information of the receiving side and checking channel state of each antenna.

4. The method of claim 1, wherein said channel coding uses a coding method that generates systematic bits.

5. The method of claim 1, wherein the interleaving fashion comprises:
rearranging the bits; and
mixing the bits that are rearranged and separated.

6. The method of claim 5, wherein the rearranging of the bits is carried out by arranging the bits in such a way that systematic bits and parity bits are separately positioned.

7. The method of claim 1, wherein the channel information of the receiving side is a retransmission request signal of a frame if ARQ (Automatic Repeat reQuest) is used and is SINR information of each antenna if pilot symbol is used.

8. The method of claim 1, wherein the rearranging of the bits is carried out by arranging the bits in such a way that systematic bits and parity bits are positioned according to priority pattern based on modulation method.

9. The method of claim 1, wherein the selecting of a particular antenna comprises:
receiving and checking the channel information of the receiving side; and
selecting an antenna through which systematic bits are to be sent.

10. The method of claim 1, wherein the modulating of the rearranged bits is carried out by mapping the rearranged bits between bit symbols of constellation according to a bit priority pattern if SMP is applied.

11. The method of claim 1, wherein the determining of whether symbol mapping based on priority is to be applied comprises, if ARQ (Automatic Repeat reQuest) is used:
checking for an error in a frame received by the receiving side;
estimating an antenna having a good channel state based on the checked error in the frame; and
feeding back predicted channel state information to a transmitting side.

12. The method of claim 11, wherein the antenna having a good channel state is one of antennas excluding an antenna that has carried out transmission of systematic bits, in case the error has occurred in every frame.

13. The method of claim 11, wherein the antenna having a good channel state is an antenna that has carried out transmission of systematic bits, in case the error has occurred not in every frame.

14. The method of claim 11, wherein the predicted channel state information is information for determining an antenna through which systematic bits are to be transmitted in next transmission.

15. The method of claim 1, wherein the determining of whether symbol mapping based on priority is to be applied comprises, in case a pilot symbol insertion method is used:
checking a pilot symbol of a frame received by the receiving side;
estimating an antenna having a good channel state based on checked information; and
feeding back predicted channel state information to a transmitting side.

16. The method of claim 15, wherein the predicted channel state information is information for determining an antenna through which systematic bits are to be transmitted in next transmission.

17. A recording medium having a program written therein for allocating bits in a multiple input multiple output communication system, the program having written therein a computer-readable and computer-executable program code for the method of claim 1.
